(19) United States
(12) Patent Application Publication
(10) Pub. No.: US 2015/0303417 A1
(43) Pub. Date: Oct. 22, 2015

(54) Rechargeable battery device

(71) Applicant: Robert Bosch GmbH, Stuttgart (DE)

(72) Inventors: Thilo KOEDER, Leinfelden-Echterdingen (DE); Esther BOHN, Gerlingen (DE); Stefan RUEBENACKE, Reutlingen (DE); Maik RABE, Reutlingen (DE); Constanze SORHAGE, Stuttgart (DE); Wolf ZAHN, Stuttgart (DE)

(21) Appl. No.: 14/689,428

(22) Filed: Apr. 17, 2015

(30) Foreign Application Priority Data
Apr. 17, 2014 (DE) 10 2014 207 418.5
Aug. 26, 2014 (DE) 10 2014 216 927.5
Jan. 29, 2015 (DE) 10 2015 201 574.2

(51) Int. Cl. H01M 2/10; H01M 10/0525

(52) U.S. Cl. CPC H01M 2/1055; H01M 10/0525; H01M 2220/30

(57) ABSTRACT

A rechargeable battery device, in particular to a handheld power tool rechargeable battery device, includes a housing, a mechanical interface unit to a detachable coupling to a handheld power tool, an electrical interface unit to a detachable coupling to the handheld power tool and at least one energy storage unit, which is situated inside the housing and which includes the at least one at least essentially cylindrical lithium-ion secondary cell. The at least one lithium-ion secondary cell has a maximum diameter which has a value from a value range between 19.5 mm and 22.5 mm.

### RELATED APPLICATION INFORMATION

The present application claims priority to and the benefit of German Patent Application No. 10 2014 207 418.5, which was filed in Germany on Apr. 17, 2014; German Patent Application No. 10 2014 216 927.5, which was filed in Germany on Aug. 26, 2014; German Patent Application No. and 10 2015 201 574.2, which was filed in Germany on Jan. 29, 2015, the disclosures of all of which are incorporated herein by reference.

### FIELD OF THE INVENTION

The present invention relates to a rechargeable battery device.

### BACKGROUND INFORMATION

A rechargeable battery device has already been proposed which includes a housing, a mechanical interface unit to a detachable coupling to a handheld power tool, an electrical interface unit to a detachable coupling to the detachable handheld power tool, and at least one energy storage unit, which is situated inside the housing and which includes at least one at least essentially cylindrical lithium-ion secondary cell.

### SUMMARY OF THE INVENTION

The present invention is directed to a rechargeable battery device, in particular to a handheld power tool rechargeable battery device, which includes a housing, a mechanical interface unit to a detachable coupling to a handheld power tool, an electrical interface unit to a detachable coupling to the handheld power tool and includes at least one energy storage unit which is situated inside the housing and which includes at least one at least essentially cylindrical lithium-ion secondary cell.

It is provided that the at least one lithium-ion secondary cell has a maximum diameter which has a value from a value range between 19.5 mm and 22.5 mm.

In this way, an electrical storage capacity of the rechargeable battery device may be advantageously adapted to an application purpose. A weight of the rechargeable battery device may be adapted to an application purpose. A rechargeable battery device which may be used in a particularly versatile way may be provided. A “rechargeable battery device” should in this context in particular be understood to mean a device for an electrical energy storage which is provided to be disconnected and/or connected to a handheld power tool for repeated charging operations and to a power supply of the handheld power tool for a repeated discharging operation. It is conceivable that the rechargeable battery device is provided for a power supply of a different electric machine, for a steady-state operated machine, for example. The rechargeable battery device may be provided for an electric power supply of a drive unit of the handheld power tool. A “mechanical interface unit” should in this context in particular be understood to mean a unit which is provided to connect the rechargeable battery device without the use of tools, repeatedly, to the handheld power tool in a form-locked manner and/or force-fit manner, and to disconnect the rechargeable battery device without the use of tools, repeatedly and nondestructively from the handheld power tool.

The interface unit may include at least one latching means and/or at least one engaging means which is provided for the form-locked and/or force-fit connection with the handheld power tool. An “electrical interface unit” should in this context in particular be understood to mean a unit which is provided to electrically connect the rechargeable battery device without the use of tools, repeatedly, for the transmission of power and/or signals to the handheld power tool, in a form-locked manner and/or force-fit manner, and to electrically disconnect the rechargeable battery device without the use of tools, repeatedly and nondestructively from the handheld power tool. A “lithium-ion secondary cell” should in this context be understood to mean a repeatedly rechargeable electrochemical cell which uses lithium ions for receiving, storing and outputting electrical energy. The lithium-ion secondary cell may include an encasing which encloses reactive materials of the lithium-ion secondary cell and protects them from external influences. The encasing may be configured to be rigid. However, it is also conceivable that the encasing is configured to be pliable. The lithium-ion secondary cell may include at least two contact means for an electrical contacting of the lithium-ion secondary cell.

The lithium-ion secondary cell may be configured in the shape of a straight circular cylinder and has a cylinder cross section having a diameter which corresponds to the maximum diameter of the lithium-ion secondary cell. It is generally also conceivable that the lithium-ion secondary cell has a different shape, for example, that of a general prism. “Provided” should in particular be understood to mean specifically configured and/or equipped. An object provided for a particular function should be understood to mean, in particular, that the object fulfills and/or carries out this particular function in at least one application state and/or operating state.

In an advantageous embodiment, the at least one lithium-ion secondary cell has a maximum diameter which has a value from a value range between 19.5 mm and 20.5 mm. In this way, an electrical storage capacity and/or the dimensions may be adapted particularly flexibly to an application purpose of the rechargeable battery device. A rechargeable battery device for a large number of application purposes may be provided.

In another advantageous embodiment, the at least one lithium-ion secondary cell has a maximum diameter which has a value from a value range between 21.5 mm and 22.5 mm. In this way, a rechargeable battery device having a large electric storage capacity and at the same time including a small number of lithium-ion secondary cells may be provided. A particularly compact rechargeable battery device may be provided.

It is furthermore provided that the at least one lithium-ion secondary cell has a volume which has a value from a value range between 19.9 cm³ and 27.1 cm³. In this way, a rechargeable battery device having a particularly small internal resistance may be provided. A rechargeable battery device having a particularly high maximum power output may be provided. A particularly large heat dissipation over front sides of the lithium-ion secondary cell may be achieved.

In an advantageous embodiment, the at least one lithium-ion secondary cell has a main extension which has a value from a value range between 64 mm and 71 mm. In this way, the dimensions of the rechargeable battery device may be advantageously adapted to different application purposes. In this context, a “main extension” should, in particular, be understood to mean a maximum extension. The main extension may correspond to a cylinder height of the lithium-ion secondary cell.

The at least one lithium-ion secondary cell is advantageously configured as a 20650 cell type, as a 20700 cell type, or as a 22700 cell type. In this way, known function and/or assembly concepts may be used for the manufacturing and/or for the use of the rechargeable battery device. A particularly cost-effective assembly process may be achieved. In this context, a cell type should, in particular, be understood to mean a normalized, standardized and/or commercially commonly used type designation for cylindrical electrochemical cells. The cell type designation may include five digits of which a first and a second digit designate a diameter of the cell in millimeters and of which a third and a fourth digit designate a cylinder height in millimeters.

In addition, it is provided that the at least one lithium-ion secondary cell has a capacity of at least 3.0 Ah. In this way, a rechargeable battery device having a particularly long operating time between two charging operations may be provided. A high user convenience may be achieved. The lithium-ion secondary cell may have a capacity of at least 3.5 Ah, which may be of at least 4.0 Ah, and particularly may be of at least 4.5 Ah.

In one advantageous embodiment, the at least one lithium-ion secondary cell has an energy density of at least 500 Wh/l. In this way, a particularly compact rechargeable battery device may be provided. A high user convenience may be achieved. An energy density should in this context be understood to mean, in particular, a maximum energy density with respect to a volume. The at least one lithium-ion secondary cell may have an energy density of at least 520 Wh/l, which may be of at least 560 Wh/l, and particularly may be of at least 600 Wh/l.

It is furthermore provided that the at least one energy storage unit has a total cell volume between 60.8 cm³ and 220.4 cm³. In this way, a particularly compact rechargeable battery device may be provided. A particularly light rechargeable battery device may be provided. In this context, a “total cell volume” should be understood to mean, in particular, a sum of the volumes of the lithium-ion secondary cells of the energy storage unit. The rechargeable battery device may include at least three lithium-ion secondary cells. The rechargeable battery device may include maximally ten lithium-ion secondary cells. The lithium-ion secondary cells may be configured as a 20650 cell type or as a 20700 cell type. The lithium-ion secondary cells particularly may be connected in series.

In an advantageous embodiment, the at least one energy storage unit has a total cell volume between 79.3 cm³ and 266.6 cm³. In this way, a rechargeable battery device having a small number of cells and a large storage capacity may be provided. The rechargeable battery device may include at least three lithium-ion secondary cells. The rechargeable battery device may include maximally ten lithium-ion secondary cells. The lithium-ion secondary cells may be configured as a 22700 cell type. The lithium-ion secondary cells particularly may be connected in series.

In another advantageous embodiment, the at least one energy storage unit has a total cell volume between 122.0 cm³ and 440.3 cm³. In this way, a rechargeable battery device simultaneously having favorable values for a storage capacity and for a weight may be provided. The rechargeable battery device may include at least six lithium-ion secondary cells. The rechargeable battery device may include maximally twenty lithium-ion secondary cells. The lithium-ion secondary cells may be configured as a 20650 cell type or as a 20700 cell type. Particularly, respectively one half of the secondary cells may be connected in series, and a first half may be connected in parallel to a second half.

In another advantageous embodiment, the at least one energy storage unit has a total cell volume between 159.2 cm³ and 532.7 cm³. In this way, a storage capacity of the rechargeable battery device may be further increased. The rechargeable battery device may include at least six lithium-ion secondary cells. The rechargeable battery device may include maximally twenty lithium-ion secondary cells. The lithium-ion secondary cells may be configured as a 22700 cell type. Particularly, respectively one half of the secondary cells may be connected in series, and a first half may be connected in parallel to a second half.

It is furthermore provided that the at least one energy storage unit has a total cell volume between 612.1 cm³ and 660.2 cm³. In this way, a rechargeable battery device having a particularly large storage capacity may be provided. A rechargeable battery device having a particularly low internal resistance and a particularly high maximum current intensity may be provided. A rechargeable battery device having a particularly high maximum power output may be provided. The rechargeable battery device may include at least thirty lithium-ion secondary cells. The lithium-ion secondary cells may be configured as a 20650 cell type or as a 20700 cell type. Particularly, the energy storage unit may include a plurality of groups in which three of the lithium-ion secondary cells are connected in parallel, the groups being connected in series. Alternatively, one third of the lithium-ion secondary cells may be connected with one another in series and that a first third, a second third, and a third third of the lithium-ion secondary cells may be connected in parallel.

It is furthermore provided that the at least one energy storage unit has a total cell volume between 797.8 cm³ and 798.8 cm³. In this way, a maximum storage capacity of the rechargeable battery device and a maximum power output of the rechargeable battery device may be further increased. The rechargeable battery device may include at least thirty lithium-ion secondary cells. The lithium-ion secondary cells may be configured as a 22700 cell type. Particularly, one third of the secondary cells may be respectively connected in series, and a first third, a second third and a third third of the lithium-ion secondary cells may be connected in parallel.

In one advantageous embodiment, the mechanical interface unit has an insertion direction which is positioned at least essentially in parallel to a main extension of the at least one lithium-ion secondary cell. In this way, the dimensions of the rechargeable battery device may be adapted to an application purpose. A rechargeable battery device having a particularly small extension in the insertion direction may be provided. An “insertion direction” should in this context be understood to mean in particular a direction in which the rechargeable battery device is moved toward a coupling with reference to the handheld power tool. The interface unit may be provided in an at least essentially linear coupling movement of the rechargeable battery device with reference to the handheld power tool. The rechargeable battery device may include a plurality of lithium-ion secondary cells whose main extension is respectively parallel to the insertion direction.

In another advantageous embodiment, the mechanical interface unit has an insertion direction which is situated at least essentially perpendicularly to a main extension of the at least one lithium-ion secondary cell. In this way, the dimensions of the rechargeable battery device may be adapted to an application purpose. A rechargeable battery device having a particularly small extension perpendicular to the insertion direction may be provided. The rechargeable battery device may include a plurality of lithium-ion secondary cells whose main extension is perpendicular to the insertion direction.

It is furthermore provided that the at least one energy storage unit includes a configuration plane and a plurality of lithium-ion secondary cells, which have an identical cross section including a central point axis, which are all situated on the configuration plane. In this way, a particularly flat rechargeable battery device may be provided. The central point axes may be positioned in parallel to one another.

In another advantageous embodiment, the at least one energy storage unit has one first configuration plane and at least one additional configuration plane, and a plurality of lithium-ion secondary cells which have an identical cross section including a central point axis, a part of the central point axes being situated on the first configuration plane, and an additional part being situated on the additional configuration plane. In this way, a rechargeable battery device having a particularly small maximum extension may be provided. A simple contacting of the lithium-ion secondary cells may be achieved. All central point axes may be situated on one of the two configuration planes. The lithium-ion secondary cells may have cross sections including central points which are positioned on a rectangular grid, particularly advantageously on a square grid. It is also conceivable that the central points are positioned on a triangular grid.

Furthermore, a system is provided including at least one rechargeable battery device according to the present invention and a handheld power tool. In this way, a system which is particularly flexibly usable may be provided. A system may be provided including a particularly long operating time between two charging operations. In this context, a “handheld power tool” should be understood to mean, in particular, a machine for machining workpieces, advantageously, however, a power drill, a drill hammer and/or percussion hammer, a saw, a planer, a screwdriver, a milling tool, a grinder, an angle grinder, a garden tool, for example, an electric hedge trimmer and/or a multi-functional tool.

Furthermore, a system is provided including at least two rechargeable battery devices, in particular including two rechargeable battery devices according to the present invention, and including a handheld power tool which includes at least one rechargeable battery interface unit which is provided to at least be coupled simultaneously to the at least two rechargeable battery devices. In this way, a system is provided having a particularly large maximum torque. A particularly powerful system may be provided. A system may be provided for a particularly long operating time. In this context, “at least coupled simultaneously” should be understood to mean that the handheld power tool is operatable using one of the rechargeable battery devices or using both rechargeable battery devices.

Furthermore, a system is provided including a handheld power tool and at least one adapter device which includes one first interface for the coupling to the handheld power tool and at least one second interface which is provided to be coupled simultaneously to at least two rechargeable battery devices, in particular to rechargeable battery devices according to the present invention.

In this way, a system may be provided which may be adapted particularly easily to different application purposes. For example, on the one hand to an application which requires a low weight and a low maximum torque, and on the other hand to an application which requires a high maximum torque. The adapter device may be provided to simultaneously connect two rechargeable battery devices electrically and mechanically to the handheld power tool. It is also conceivable that the adapter device includes a selector switch, which is provided to optionally electrically connect one of the two rechargeable battery devices, both rechargeable battery devices, or no rechargeable battery device to the handheld power tool.

Furthermore, a system is provided including a handheld power tool and at least one rechargeable battery device according to the present invention and including at least one replacement rechargeable battery device which includes at least one lithium-ion secondary cell of the 18650 type, the handheld power tool being optionally operatable using the rechargeable battery device or using the replacement rechargeable battery device. A system may thus be provided which may be adapted particularly easily to different application purposes. A system may be provided for a particularly large application area. With a rechargeable battery replacement, a particularly long operating time may be achieved. In this context, a “replacement rechargeable battery device” should be understood to mean in particular a device which is provided for an equivalent function as the rechargeable battery device. The replacement rechargeable battery device is provided in particular for a power supply of at least the drive unit of the handheld power tool. The replacement rechargeable battery device and the rechargeable battery device may have an identical nominal voltage. The lithium-ion secondary cells of the replacement rechargeable battery device of the 18650 type may have a capacity of 3.0 Ah. It is conceivable that the lithium-ion secondary cells of the replacement rechargeable battery device have a higher capacity.

Furthermore, a handheld power tool of such a system is provided including at least one rechargeable battery device, in particular including at least one rechargeable battery device according to the present invention. In this way, a handheld power tool for a particularly large application area may be provided. A handheld power tool having a particularly high maximum torque may be provided. A handheld power tool having a particularly long operating time between two charging operations may be provided.

Furthermore, an adapter device of such a system is provided including at least one rechargeable battery device, in particular including at least one rechargeable battery device according to the present invention, which makes it possible to provide a particularly simple adapter device.

The rechargeable battery device according to the present invention is, however, not limited to the application and the specific embodiment described above. The rechargeable battery device according to the present invention may in particular have a number of individual elements, components and units which deviates from the number given here to fulfill the functionality described herein.

Further advantages result from the following description of the drawings. Eight exemplary embodiments of the present invention are illustrated in the drawings. The drawings, the description, and the claims contain many features in combination. Those skilled in the art will advantageously also consider the features individually and combine them to form further meaningful combinations.

### BRIEF DESCRIPTION OF THE DRAWINGS

FIG. 1 shows a system including a handheld power tool and a rechargeable battery device according to the present invention in a perspective view.

FIG. 2 shows the rechargeable battery device in a perspective view.

FIG. 3 shows the rechargeable battery device in a top view.

FIG. 4 shows a partially sectioned side view of the rechargeable battery device.

FIG. 5 shows a partially sectioned rear view of the rechargeable battery device.

FIG. 6 shows a lithium-ion secondary cell in a perspective view.

FIG. 7 shows an additional exemplary embodiment of the rechargeable battery device in a partially sectioned side view.

FIG. 8 shows a third exemplary embodiment of the rechargeable battery device in a partially sectioned side view.

FIG. 9 shows a fourth exemplary embodiment of the rechargeable battery device in a partially sectioned side view.

FIG. 10 shows a lithium-ion secondary cell of the rechargeable battery device in a perspective view.

FIG. 11 shows a fifth exemplary embodiment of the rechargeable battery device in a partially sectioned side view.

FIG. 12 shows a lithium-ion secondary cell of the rechargeable battery device in a perspective view.

FIG. 13 shows a system including a hand-held power tool and two rechargeable battery devices in a perspective view.

FIG. 14 shows a system including a hand-held power tool, an adapter device and two rechargeable battery devices in a perspective view.

FIG. 15 shows the rechargeable battery device in a perspective view.

FIG. 16 shows a system including a handheld power tool, a rechargeable battery device and a replacement rechargeable battery device in a perspective view.

### DETAILED DESCRIPTION

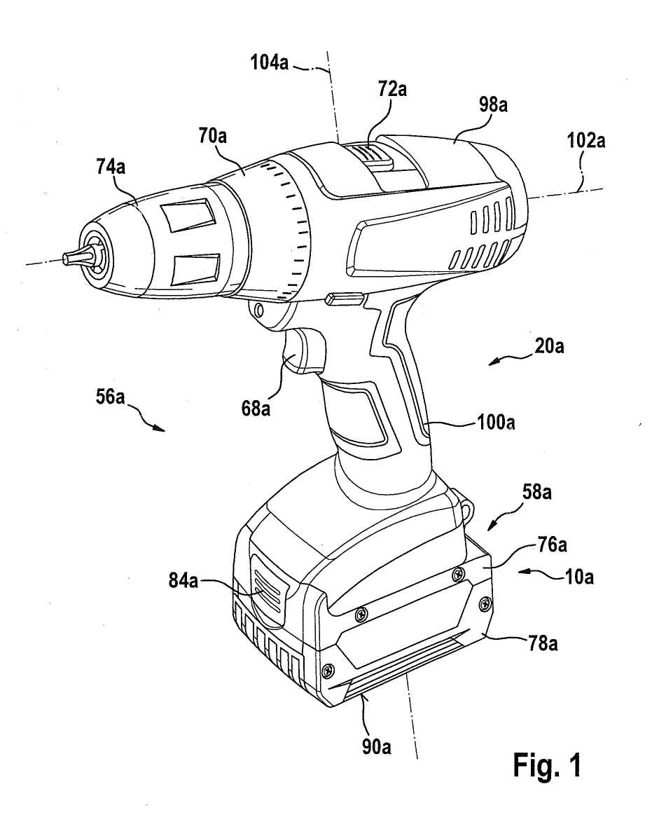

FIG. 1 shows a system 56a including a handheld power tool 20a and including a rechargeable battery device 10a. Handheld power tool 20a is configured in the present exemplary embodiment as a cordless screwdriver. Handheld power tool 20a includes an electric drive unit, which includes an electric motor. Handheld power tool 20a furthermore includes a tool holder 74a for holding an insert tool, for example, of a screwdriver blade, a drill or a stirrer. The drive unit is provided for a rotatory operation of tool holder 74a.

Handheld power tool 20a is in the present exemplary embodiment configured in the shape of a pistol. Handheld power tool 20a includes a drive and a work area 98a and a grip area 100a. Handheld power tool 20a includes a drive and work axis 102a and a grip axis 104a. Drive and work axis 102a and grip axis 104a enclose an angle of approximately 82 degrees. It is conceivable that the drive and work axis 102a and the grip axis 104a enclose an angle which has a value in a value range between 60 degrees and 90 degrees. It is also conceivable that the drive and work axis 102a and the grip axis 104a are aligned or positioned to one another at a different angle which appears advantageous to those skilled in the art for the respective application.

Handheld power tool 20a includes a switching unit which is provided to switch handheld power tool 20a on and/or off and/or to set a speed and/or a torque. The switching unit includes an operating element 68a which is provided for an operation by a user. Operating element 68a is configured as a pressure switch. Handheld power tool 20a includes a torque limiter which is provided to set a torque maximally transferred by the drive unit to tool holder 74a. The torque limiter includes an adjustment ring 70a which is provided for an operation by the user. Handheld power tool 20a includes a gear shifting device which is provided to set a gear. The gear shifting device includes an operating element 72a which is provided for an operation by a user. Operating element 72a is configured in the present exemplary embodiment as a sliding element. Handheld power tool 20a is configured for a power supply by rechargeable battery device 10a. Handheld power tool 20a includes a rechargeable battery interface unit 58a for rechargeable battery device 10a. Rechargeable battery interface unit 58a for rechargeable battery device 10a is situated at an end of grip area 100a facing away from drive and work area 98a.

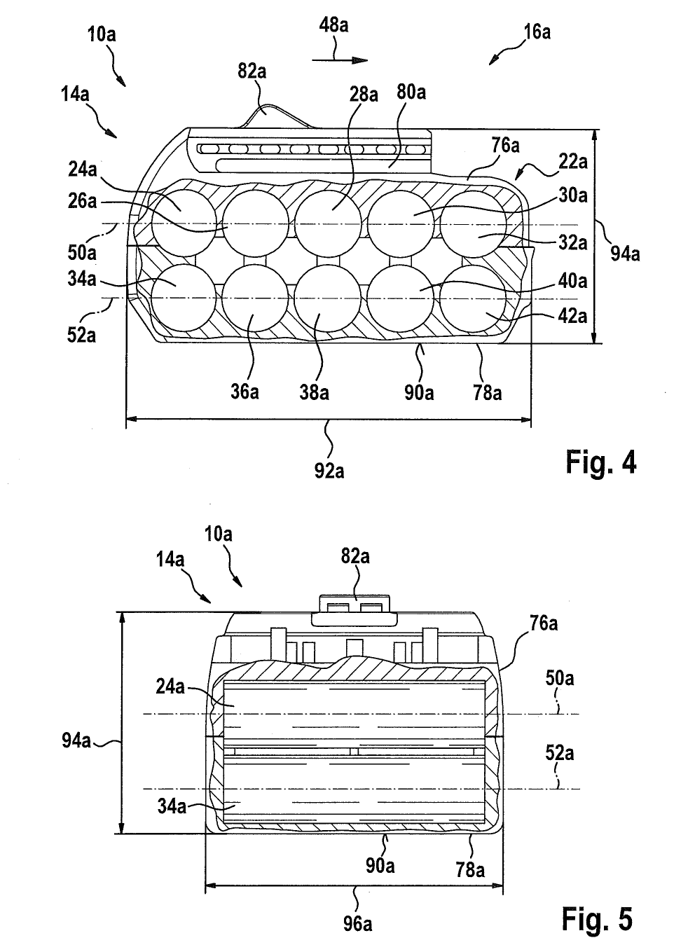

Rechargeable battery device 10a is provided for a power supply of the electric drive unit of handheld power tool 20a. Rechargeable battery device 10a includes a housing 14a and an energy storage unit 22a. Energy storage unit 22a includes at least one lithium-ion secondary cell 24a through 42a. Energy storage unit 22a includes a plurality of lithium-ion secondary cells 24a through 42a (see FIG. 4 and FIG. 5.) Housing 14a accommodates energy storage unit 22a including lithium-ion secondary cells 24a through 42a connected in parallel and/or in series as rechargeable battery cells. It is also conceivable that rechargeable battery device 10a includes rechargeable battery cells having a different chemical composition, for example, sodium-ion cells, nickel-ion cells, zinc-ion cells or tin-ion cells. Housing 14a includes a first housing element 76a and a second housing element 78a.

Rechargeable battery device 10a in the shown embodiment variant is configured as a sliding rechargeable battery pack. Rechargeable battery device 10a has an insertion direction 48a.

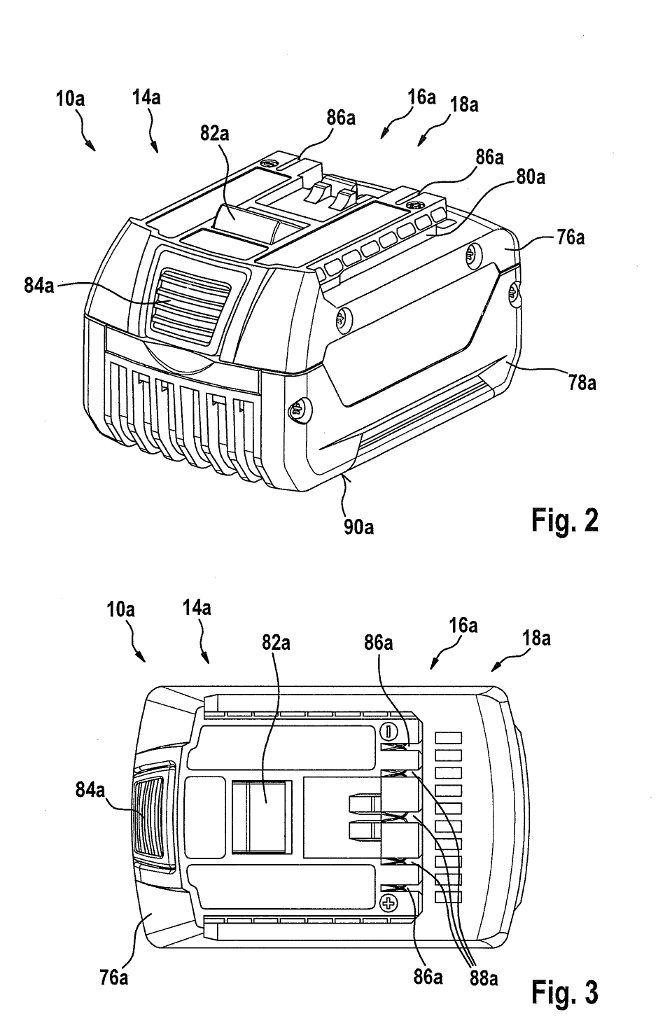

For the detachable attachment of rechargeable battery device 10a to handheld power tool 20a or to a charging device, rechargeable battery device 10a includes a mechanical interface unit 16a for the detachable mechanical connection to rechargeable battery interface unit 58a of handheld power tool 20a or to a charging device not shown in greater detail (see FIG. 2 and FIG. 3.) Mechanical interface unit 16a of rechargeable battery device 10a and rechargeable battery interface unit 58a of handheld power tool 20a are configured to correspond to each other. For a detachable electrical connection of rechargeable battery device 10a to handheld power tool 20a or to a charging device not shown in greater detail, rechargeable battery device 10a includes an electrical interface unit 18a for the detachable electrical connection to rechargeable battery interface unit 58a of handheld power tool 20a or of the charging device.

Mechanical interface unit 16a includes guide elements 80a in the form of guide grooves which are provided to act together with corresponding guide elements in the form of guide ribs at handheld power tool 20a or at the charging device. The guide grooves extend in the direction of insertion direction 48a of rechargeable battery device 10a. The guide grooves set insertion direction 48a. It is conceivable that guide elements 80a of rechargeable battery device 10a are configured as guide ribs, and are provided to act together with corresponding guide grooves at handheld power tool 20a or at the charging device. Mechanical interface unit 16a furthermore includes a locking element 82a in the shape of a spring-loaded bolt. For the operation of locking element 82a, an operating element 84a is provided in the form of a push button. For locking rechargeable battery device 10a to handheld power tool 20a or the charging device, locking element 82a engages with a locking recess which is formed at rechargeable battery interface unit 58a of handheld power tool 20a or to a charging device. Vice versa, in an alternative embodiment, which is not shown, a locking element 82a may be situated at interface unit 16a of handheld power tool 20a or of the charging device and the corresponding locking recess may be situated at interface unit 16a of rechargeable battery device 10a.

Electrical interface unit 18a includes contact elements 86a, 88a for an electrical contacting of rechargeable battery device 10a to handheld power tool 20a or to the charging device. Contact elements 86a are configured as voltage contact elements and serve as charging and/or discharging contact elements. Contact elements 88a are configured as signal contact elements and serve for the signal transmission from rechargeable battery device 10a to handheld power tool 20a or to the charging device and/or from handheld power tool 20a or the charging device to rechargeable battery device 10a.

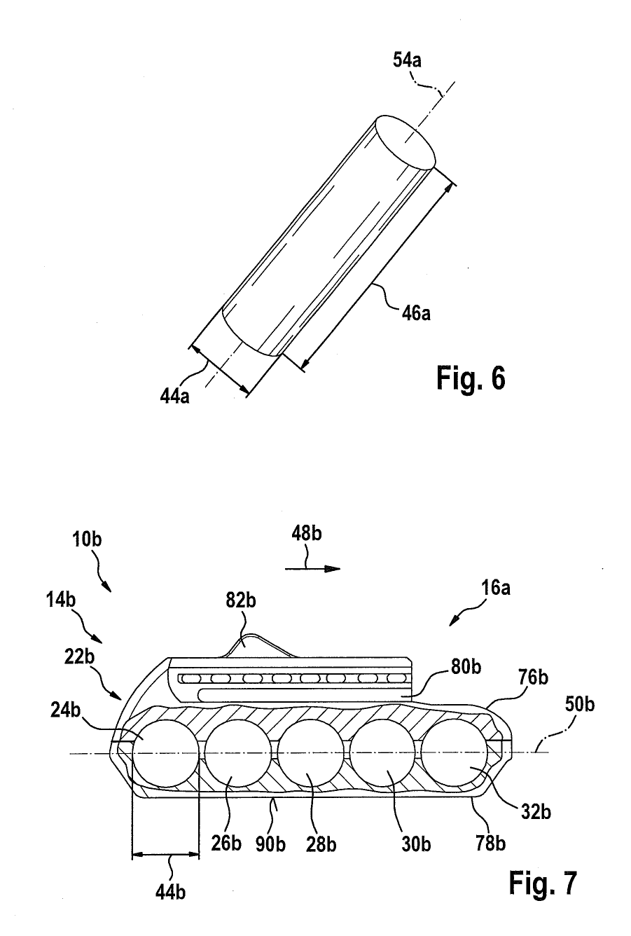

Lithium-ion secondary cells 24a through 42a are each configured cylindrically (see FIG. 6). Lithium-ion secondary cells 24a through 42a are each configured in the shape of a straight circular cylinder and each have a cross section including a central point axis 54a which corresponds to a cylinder axis. Lithium-ion secondary cells 24a through 42a are configured identically to one another. Lithium-ion secondary cells 24a through 42a have a main extension 46a. Main extension 46a and central point axis 54a of lithium-ion secondary cells 24a through 42a are each positioned in parallel to one another. Lithium-ion secondary cells 24a through 42a include an identical maximum diameter 44a. In the present exemplary embodiment, maximum diameter 44a of lithium-ion secondary cells 24a through 42a has a value of approximately 20 mm. In the present exemplary embodiment, maximum diameter 44a of lithium-ion secondary cells 24a through 42a has a value from a value range between 19.5 mm and 20.5 mm.

Lithium-ion secondary cells 24a through 42a have an identical volume which has a value from a value range between 19.9 cm³ to 27.1 cm³. In the present exemplary embodiment, lithium-ion secondary cells 24a through 42a have an identical volume which has a value of approximately 20.4 cm³. Lithium-ion secondary cells 24a through 42a have an identical main extension 46a which has a value of a value range between 64 mm and 71 mm. In the present exemplary embodiment, lithium-ion secondary cells 24a through 42a have an identical main extension 46a which has a value of approximately 65 mm. Lithium-ion secondary cells 24a through 42a are each configured as a 20650 cell type. Lithium-ion secondary cells 24a through 42a each have a capacity of 4.0 Ah. It is conceivable that lithium-ion secondary cells 24a through 42a have a higher capacity. Lithium-ion secondary cells 24a through 42a each have an identical energy density of approximately 500 Wh/l. It is conceivable that lithium-ion secondary cells 24a through 42a have a higher energy density.

In the present exemplary embodiment, energy storage unit 22a of rechargeable battery device 10a includes ten lithium-ion secondary cells 24a through 42a. Rechargeable battery device 10a includes in the present exemplary embodiment five groups of two lithium-ion secondary cells 24a through 42a each connected in parallel. The groups are connected in series. Lithium-ion secondary cells 24a through 42a have an identical nominal voltage of approximately 3.6 volts. Rechargeable battery device 10a has a nominal voltage of approximately 18.0 volts. In the present exemplary embodiment, energy storage unit 22a has a total cell volume of approximately 204.2 cm³. Lithium-ion secondary cells 24a through 42a each have an identical cross-sectional area of approximately 3.1 cm². The cross-sectional area extends in a plane perpendicular to the central point axis 54a of lithium-ion secondary cell 24a through 42a. In the present exemplary embodiment, energy storage unit 22a has a total cross-sectional area of approximately 31.4 cm². It is conceivable that rechargeable battery device 10a includes a different number of lithium-ion secondary cells 24a through 42a, for example, six, eight, fourteen, twenty or thirty lithium-ion secondary cells 24a through 42a. As a function of a number of lithium-ion secondary cells 24a through 42a connected in series, rechargeable battery device 10a has a nominal voltage of 10.8 V, 14.4 V, 25.2 V or 36.0 V. As a function of the number of lithium-ion secondary cells 24a through 42a, energy storage unit 22a has a total cell volume between 122.0 cm³ and 408.9 cm³ or of approximately 612.6 cm³. As a function of the number of lithium-ion secondary cells 24a through 42a, energy storage unit 22a has a total cross sectional area between 18.3 cm² and 63.3 cm² or of approximately 94.2 cm².

Insertion direction 48a and main extension 46a of lithium-ion secondary cells 24a through 42a are aligned perpendicularly to one another in the present exemplary embodiment. Housing 14a of rechargeable battery device 10a includes a base area 90a which is diametrically opposed to mechanical interface unit 16a and electrical interface unit 18a. A maximum extension of rechargeable battery device 10a, base area 90a and main extension 46a of lithium-ion secondary cells 24a through 42a are displaced in parallel to one another. In the present exemplary embodiment, rechargeable battery device 10a has a length 92a of approximately 121 mm. In the present exemplary embodiment, rechargeable battery device 10a has a height 94a of approximately 61 mm. In the present exemplary embodiment, rechargeable battery device 10a has a width 96a of approximately 80 mm. Length 92a corresponds to the maximum extension of rechargeable battery device 10a. Base area 90a is situated in the direction of length 92a and of width 96a.

Energy storage unit 22a has a first configuration plane 50a and at least one additional configuration plane 52a. Configuration planes 50a, 52a are positioned in parallel to one another. In the present exemplary embodiment, configuration planes 50a, 52a are aligned in parallel to base area 90a. Central point axes 54a of the first group of lithium-ion secondary cells 24a through 32a are situated on first configuration plane 50a. Central point axes 54a of the additional group of lithium-ion secondary cells 34a through 42a are situated on additional configuration plane 52a. All central point axes 54a are each situated on first configuration plane 50a or on additional configuration plane 52a. It is conceivable that configuration planes 50a, 52a are situated perpendicularly to base area 90a. It is conceivable that configuration planes 50a, 52a are here perpendicular to insertion direction 48a or in parallel to insertion direction 48a. Lithium-ion secondary cells 24a through 42a of the first group form a first layer. Lithium-ion secondary cells 24a through 42a of the additional group form an additional layer. One lithium-ion secondary cell 24a through 32a of the first group is each spatially assigned to one lithium-ion secondary cell 34a through 42a of the additional group. One plane, which is established by central point axes 54a of lithium-ion secondary cells 24a through 42a assigned to one another, is situated perpendicularly to configuration planes 50a, 52a. The cross sections of lithium-ion secondary cells 24a through 42a each have a central point. The central points are positioned on a square grid. Alternatively it is conceivable that the groups are positioned offset to one another and that the central points of the cross sections are positioned on a triangular grid. It is furthermore conceivable that the energy storage unit 22a has a number of configuration planes 50a, 52a deviating from two configuration planes and central point axes 54a are situated, for example, on one single or on one of three or on one of four configuration planes 50a, 52a. Accordingly energy storage unit 22a includes a number deviating from two of layers of lithium-ion secondary cells 24a through 42a.

Seven further exemplary embodiments of the present invention are shown in FIGS. 7 through 16. The following descriptions and drawings are essentially limited to the differences between the exemplary embodiments, it also being possible to make references with regard to identically identified components, in particular to components having identical reference numerals, basically also to the drawings and/or the description of the other exemplary embodiments, in particular of FIGS. 1 through 6. To differentiate between the exemplary embodiments, the letter “a” is added as a suffix to the reference numerals of the exemplary embodiment in FIGS. 1 through 6. In the exemplary embodiments in FIGS. 7 through 16, the letter “a” is replaced by the letters “b” through “h.”

FIG. 7 schematically shows a partially sectioned side view of another exemplary embodiment of rechargeable battery device 10b. Rechargeable battery device 10b is provided similarly to the preceding exemplary embodiment as a power supply of the electric drive unit of a handheld power tool. Rechargeable battery device 10b includes a housing 14b and an energy storage unit 22b. Energy storage unit 22b includes a plurality of lithium-ion secondary cells 24b through 32b. Housing 14b includes a first housing element 76b and a second housing element 78b. Rechargeable battery device 10b in the shown embodiment variant is configured as a sliding rechargeable battery pack. Rechargeable battery device 10b includes an insertion direction 48b. For the detachable attachment of rechargeable battery device 10b to the handheld power tool or to a charging device, rechargeable battery device 10b includes a mechanical interface unit 16b, similarly to the preceding exemplary embodiment, for the detachable mechanical connection to a rechargeable battery interface unit of the handheld power tool or to a charging device not shown in greater detail. For a detachable electrical connection of rechargeable battery device 10b to the handheld power tool or to a charging device not shown in greater detail, rechargeable battery device 10b includes an electrical interface unit for the detachable electrical connection to the rechargeable battery interface unit of handheld power tool or of the charging device, similarly to the preceding exemplary embodiment. Mechanical interface unit 16b includes guide elements 80b in the form of guide grooves. Mechanical interface unit 16b furthermore includes a locking element 82b in the shape of a spring-loaded bolt. For the operation of locking element 82b, an operating element is provided in the form of a push button.

Lithium-ion secondary cells 24b through 32b are each configured cylindrically. Lithium-ion secondary cells 24b through 32b are configured similarly to the preceding exemplary embodiment. Lithium-ion secondary cells 24b through 32b are each configured in the shape of a straight circular cylinder and each have a cross section including a central point axis which corresponds to a cylinder axis. Lithium-ion secondary cells 24b through 32b include an identical maximum diameter 44b. In the present exemplary embodiment, diameter 44b of lithium-ion secondary cells 24b through 32b has a value of approximately 20 mm. In the present exemplary embodiment, lithium-ion secondary cells 24b through 32b have an identical main extension which has a value of approximately 65 mm. Lithium-ion secondary cells 24b through 32b are each configured as a 20650 cell type.

In contrast to the preceding exemplary embodiment, energy storage unit 22b of rechargeable battery device 10b includes five lithium-ion secondary cells 24b through 32b which are connected in series. Lithium-ion secondary cells 24b through 32b have an identical nominal voltage of approximately 3.6 volts. Rechargeable battery device 10b has a nominal voltage of approximately 18.0 volts. In the present exemplary embodiment, energy storage unit 22b has a total cell volume of approximately 102.1 cm³. In the present exemplary embodiment, energy storage unit 22b has a total cross-sectional area of approximately 15.7 cm². It is conceivable that rechargeable battery device 10b includes a different number of lithium-ion secondary cells 24b through 32b, for example, three, four, seven or ten lithium-ion secondary cells 24b through 32b. As a function of a number of lithium-ion secondary cells 24b through 32b connected in series, rechargeable battery device 10b has a nominal voltage of 10.8 V, 14.4 V, 25.2 V or 36.0 V. As a function of the number of lithium-ion secondary cells 24b through 32b, energy storage unit 22b has a total cell volume between 60.8 cm³ and 204.7 cm³. As a function of the number of lithium-ion secondary cells 24b through 32b, energy storage unit 22b has a total cross-sectional area between 8.9 cm² and 31.9 cm².

Insertion direction 48b and the main extension of lithium-ion secondary cells 24b through 32b are aligned perpendicularly to one another in the present exemplary embodiment. Housing 14b of rechargeable battery device 10b includes a base area 90b which is diametrically opposed to mechanical interface unit 16b and the electrical interface unit. A maximum extension of rechargeable battery device 10b, base area 90b and the main extension of lithium-ion secondary cells 24b through 32b are positioned in parallel to one another. In contrast to the preceding exemplary embodiment, energy storage unit 22b has one single configuration plane 50b. Central point axes of lithium-ion secondary cells 24b through 32b are all situated on configuration plane 50b. Lithium-ion secondary cells 24b through 32b form one single layer.

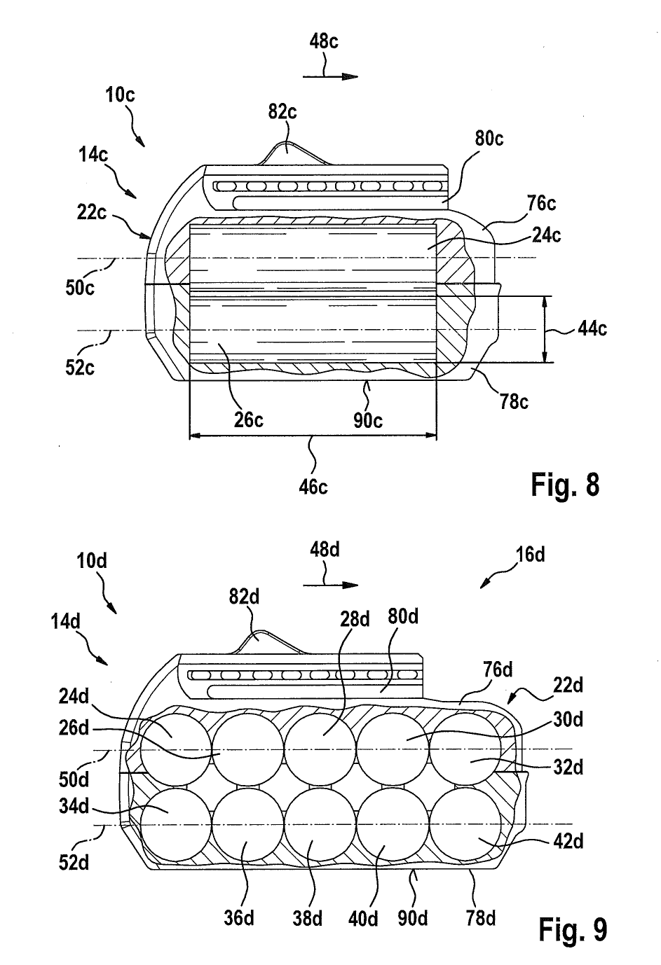

FIG. 8 shows a partially sectioned side view of another exemplary embodiment of rechargeable battery device 10c. Rechargeable battery device 10c is provided similarly to the preceding exemplary embodiment as a power supply of the electric drive unit of a handheld power tool. Rechargeable battery device 10c includes a housing 14c and an energy storage unit 22c. Energy storage unit 22c includes a plurality of lithium-ion secondary cells 24c, 26c. Housing 14c includes a first housing element 76c and a second housing element 78c. Rechargeable battery device 10c in the shown embodiment variant is configured as a sliding rechargeable battery pack. Rechargeable battery device 10c includes an insertion direction 48c. For the detachable attachment of rechargeable battery device 10c to the handheld power tool or to a charging device, rechargeable battery device 10c includes a mechanical interface unit 16c for the detachable mechanical connection to the rechargeable battery interface unit of the handheld power tool or to a charging device not shown in greater detail, similarly to the preceding exemplary embodiment. For a detachable electrical connection of rechargeable battery device 10c to the handheld power tool or to a charging device not shown in greater detail, rechargeable battery device 10c includes an electrical interface unit for the detachable electrical connection to the rechargeable battery interface unit of the handheld power tool or of the charging device, similarly to the preceding exemplary embodiment.

Mechanical interface unit 16c includes guide elements 80c in the form of guide grooves. Mechanical interface unit 16c furthermore includes a locking element 82c in the shape of a spring-loaded bolt. For the operation of locking element 82b, an operating element is provided in the form of a push button.

Lithium-ion secondary cells 24c, 26c are each configured cylindrically. Lithium-ion secondary cells 24c, 26c are configured similarly to the preceding exemplary embodiment. Lithium-ion secondary cells 24c, 26c are each configured in the shape of a straight circular cylinder and each have a cross section including a central point axis which corresponds to a cylinder axis. Lithium-ion secondary cells 24c, 26c include an identical maximum diameter 44c. In the present exemplary embodiment, diameter 44c of lithium-ion secondary cells 24c, 26c has a value of approximately 20 mm. In the present exemplary embodiment, lithium-ion secondary cells 24c, 26c have an identical main extension 46c which has a value of approximately 65 mm. Lithium-ion secondary cells 24c, 26c are each configured as a 20650 cell type. It is also conceivable that the lithium-ion secondary cells 24c, 26c are configured as a 20700 cell type or as a 22700 cell type.

In the present exemplary embodiment, energy storage unit 22c of rechargeable battery device 10c includes ten lithium-ion secondary cells 24c, 26c. Rechargeable battery device 10c includes in the present exemplary embodiment five groups of two lithium-ion secondary cells 24c, 26c each connected in parallel. The groups are connected in series. Lithium-ion secondary cells 24c, 26c have an identical nominal voltage of approximately 3.6 volts. Rechargeable battery device 10c has a nominal voltage of approximately 18.0 volts. In the present exemplary embodiment, energy storage unit 22c has a total cell volume of approximately 204.2 cm³. In the present exemplary embodiment, energy storage unit 22c has a total cross-sectional area of approximately 31.4 cm². It is conceivable that rechargeable battery device 10c includes a different number of lithium-ion secondary cells 24c, 26c, for example, three, four, six, seven, eight, fourteen, twenty or thirty lithium-ion secondary cells 24c, 26c.

In contrast to the preceding exemplary embodiments, insertion direction 48c and main extension 46c of lithium-ion secondary cells 24c, 26c are aligned in parallel to one another in the present exemplary embodiment. Insertion direction 48c and the central point axes of lithium-ion secondary cells 24c, 26c are positioned in parallel to one another. Housing 14c of rechargeable battery device 10c includes a base area 90c which is diametrically opposed to mechanical interface unit 16c and the electrical interface unit. A maximum extension of rechargeable battery device 10c, base area 90c and main extension 46c of lithium-ion secondary cells 24c, 26c are positioned in parallel to one another. Similarly to the first exemplary embodiment, energy storage unit 22c has two configuration planes 50c, 52c. The central point axes are each situated on one of configuration planes 50c, 52c. In the present exemplary embodiment, configuration planes 50c, 52c are positioned in parallel to base area 90c. It is also conceivable that the energy storage unit has a different number of configuration planes 50c, 52c, for example, only one single configuration plane or three configuration planes.

FIG. 9 shows a partially sectioned side view of another exemplary embodiment of rechargeable battery device 10d. Rechargeable battery device 10d is provided similarly to the preceding exemplary embodiment as a power supply of the electric drive unit of a handheld power tool. Rechargeable battery device 10d includes a housing 14d and an energy storage unit 22d. Energy storage unit 22d includes a plurality of lithium-ion secondary cells 24d through 42d. Housing 14d includes a first housing element 76d and a second housing element 78d. Rechargeable battery device 10d in the shown embodiment variant is configured as a sliding rechargeable battery pack. Rechargeable battery device 10d includes an insertion direction 48d. For the detachable attachment of rechargeable battery device 10d to the handheld power tool or to a charging device, rechargeable battery device 10d includes a mechanical interface unit 16d for the detachable mechanical connection to the rechargeable battery interface unit of the handheld power tool or to a charging device not shown in greater detail, similarly to the preceding exemplary embodiment. For a detachable electrical connection of rechargeable battery device 10d to the handheld power tool or to a charging device not shown in greater detail, rechargeable battery device 10d includes an electrical interface unit for the detachable electrical connection to the rechargeable battery interface unit of the handheld power tool or of the charging device, similarly to the preceding exemplary embodiment. Mechanical interface unit 16d includes guide elements 80d in the form of guide grooves. Mechanical interface unit 16d furthermore includes a locking element 82d in the shape of a spring-loaded bolt. For the operation of locking element 82d, an operating element is provided in the form of a push button.

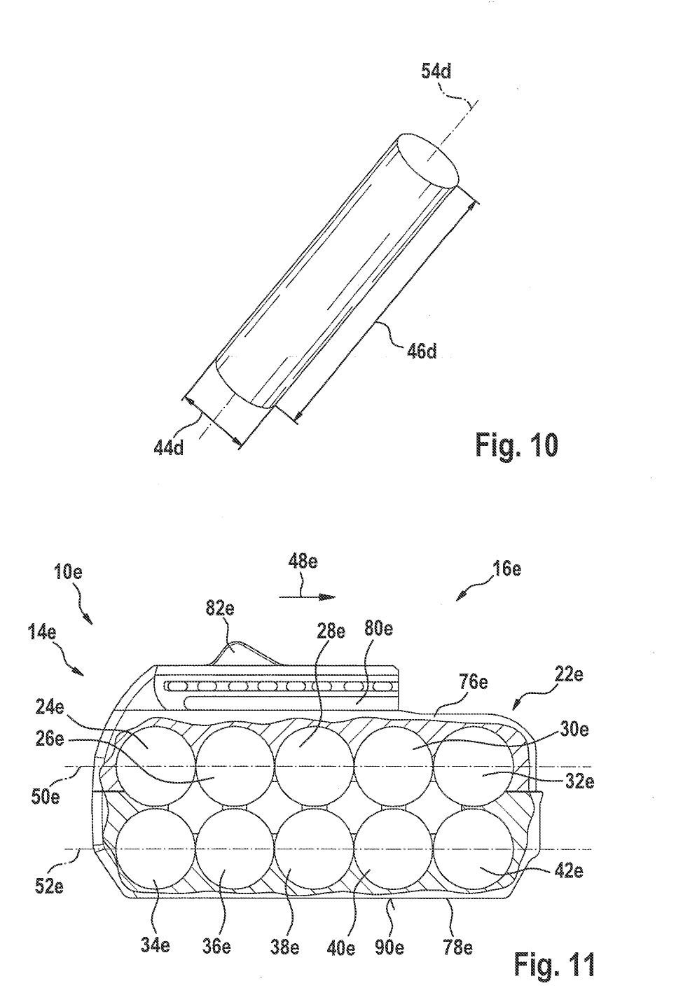

Lithium-ion secondary cells 24d through 42d are each configured cylindrically (see FIG. 10). Lithium-ion secondary cells 24d through 42d are each configured in the shape of a straight circular cylinder and each have a cross section including a central point axis 54d which corresponds to a cylinder axis. Lithium-ion secondary cells 24d through 42d include an identical maximum diameter 44d. In the present exemplary embodiment, diameter 44d of the lithium-ion secondary cells has a value of approximately 20 mm.

In contrast to the preceding exemplary embodiments, the lithium-ion secondary cells have an identical main extension 46d which has a value of approximately 70 mm. The lithium-ion secondary cells are each configured as a 20700 cell type.

In the present exemplary embodiment, energy storage unit 22d of rechargeable battery device 10d includes ten lithium-ion secondary cells 24d through 42d. In the present exemplary embodiment, rechargeable battery device 10d includes five groups of two lithium-ion secondary cells 24d through 42d each connected in parallel. The groups are connected in series. Lithium-ion secondary cells 24d through 42d have an identical nominal voltage of approximately 3.6 volts. Rechargeable battery device 10d has a nominal voltage of approximately 18.0 volts. In the present exemplary embodiment, energy storage unit 22d has a total cell volume of approximately 219.9 cm³. Lithium-ion secondary cells 24d through 42d each have an identical cross-sectional area of approximately 3.1 cm². In the present exemplary embodiment, energy storage unit 22d has a total cross-sectional area of approximately 31.4 cm². It is conceivable that rechargeable battery device 10d includes a different number of lithium-ion secondary cells 24d through 42d, for example, three, four, five, six, seven, eight, fourteen, twenty or thirty lithium-ion secondary cells 24d through 42d. As a function of the number of lithium-ion secondary cells 24d through 42d connected in series, rechargeable battery device 10d has a nominal voltage of 10.8 V, 14.4 V, 25.2 V or 36.0 V. As a function of the number of lithium-ion secondary cells 24d through 42d, energy storage unit 22d has a total cell volume between 65.5 cm³ and 440.3 cm³ or of approximately 659.7 cm³. As a function of the number of lithium-ion secondary cells 24d through 42d, energy storage unit 22d has a total cross-sectional area between 8.9 cm² and 65.3 cm² or of approximately 94.2 cm².

Insertion direction 48d and main extension 46d of lithium-ion secondary cells 24d through 42d are aligned perpendicularly to one another in the present exemplary embodiment. Housing 14d of rechargeable battery device 10d includes a base area 90d which is diametrically opposed to mechanical interface unit 16d and the electrical interface unit. A maximum extension of rechargeable battery device 10d, base area 90d and main extension 46d of lithium-ion secondary cells 24d through 42d are positioned in parallel to one another.

Similarly to the first exemplary embodiment, energy storage unit 22d has two configuration planes 50d, 52d. Configuration planes 50d, 52d are positioned in parallel to one another. Central point axes 54d are all situated on a first of configuration planes 50d or on an additional one of configuration planes 52d. It is also conceivable that the energy storage unit has a different number of configuration planes 50d, 52d, for example, only one single configuration plane or three configuration planes.

FIG. 11 shows a partially sectioned side view of another exemplary embodiment of rechargeable battery device 10e. Rechargeable battery device 10e is provided similarly to the preceding exemplary embodiment as a power supply of the electric drive unit of a handheld power tool. Rechargeable battery device 10e includes a housing 14e and an energy storage unit 22e. Energy storage unit 22e includes a plurality of lithium-ion secondary cells 24e through 42e. Housing 14e includes a first housing element 76e and a second housing element 78e. Rechargeable battery device 10e is configured as a sliding rechargeable battery pack in the shown embodiment variant. Rechargeable battery device 10e includes an insertion direction 48e. For the detachable attachment of rechargeable battery device 10e to the handheld power tool or to a charging device, rechargeable battery device 10e includes a mechanical interface unit 16e for the detachable mechanical connection to the rechargeable battery interface unit of the handheld power tool or to a charging device not shown in greater detail, similarly to the preceding exemplary embodiment. For a detachable electrical connection of rechargeable battery device 10e to the handheld power tool or to a charging device not shown in greater detail, rechargeable battery device 10e includes an electrical interface unit for the detachable electrical connection to the rechargeable battery interface unit of the handheld power tool or of the charging device, similarly to the preceding exemplary embodiment. Mechanical interface unit 16e includes guide elements 80e in the form of guide grooves. Mechanical interface unit 16e furthermore includes a locking element 82e in the form of a spring-loaded bolt. For the operation of locking element 82e, an operating element is provided in the form of a push button.

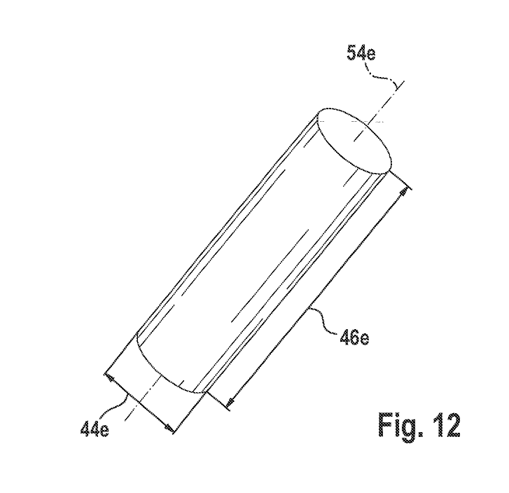

Lithium-ion secondary cells 24e through 42e are each configured cylindrically (see FIG. 12). Lithium-ion secondary cells 24e through 42e are each configured in the shape of a straight circular cylinder and each have a cross section including a central point axis 54e which corresponds to a cylinder axis. Lithium-ion secondary cells 24e through 42e include a common (an identical) maximum diameter 44e. In contrast to the preceding exemplary embodiments, diameter 44e of lithium-ion secondary cells 24e through 42e has a value of approximately 22 mm. Lithium-ion secondary cells 24e through 42e have an identical main extension 46e which has a value of approximately 70 mm. Lithium-ion secondary cells 24e through 42e are each configured as a 22700 cell type.

In the present exemplary embodiment, the energy storage unit of rechargeable battery device 10e includes ten lithium-ion secondary cells 24e through 42e. In the present exemplary embodiment, rechargeable battery device 10e includes a first group of five lithium-ion secondary cells 24e through 32e which are connected in series and an additional group of five lithium-ion secondary cells 34e through 42e which are connected in series. The first group and the second group are connected in parallel. Lithium-ion secondary cells 24e through 42e have an identical nominal voltage of approximately 3.6 volts. Rechargeable battery device 10e has a nominal voltage of approximately 18.0 volts. In the present exemplary embodiment, energy storage unit 22e has a total cell volume of approximately 266.1 cm³. In contrast to the preceding exemplary embodiments, lithium-ion secondary cells 24e through 42e each have an identical cross-sectional area of approximately 3.8 cm². In the present exemplary embodiment, energy storage unit 22e has a total cross-sectional area of approximately 38 cm². It is conceivable that rechargeable battery device 10e includes a different number of lithium-ion secondary cells 24e through 42e, for example, three, four, five, six, seven, eight, fourteen, twenty or thirty lithium-ion secondary cells 24e through 42e. As a function of a number of lithium-ion secondary cells 24e through 42e connected in series, rechargeable battery device 10e has a nominal voltage of 10.8 V, 14.4 V, 25.2 V or 36.0 V. As a function of the number of lithium-ion secondary cells 24e through 42e, energy storage unit 22e has a total cell volume between 79.3 cm³ and 532.7 cm³ or of approximately 798.3 cm³. As a function of a number of lithium-ion secondary cells 24e through 42e, energy storage unit 22e has a total cross-sectional area between 10.9 cm² and 76.5 cm² or of approximately 114.0 cm².

Insertion direction 48e and main extension 46e of lithium-ion secondary cells 24e through 42e are aligned perpendicularly to one another in the present exemplary embodiment. Housing 14e of rechargeable battery device 10e includes a base area 90e which is diametrically opposed to mechanical interface unit 16e and the electrical interface unit. A maximum extension of rechargeable battery device 10e, base area 90e and main extension 46e of lithium-ion secondary cells 24e through 42e are positioned in parallel to one another. Similarly to the first exemplary embodiment, energy storage unit 22e has two configuration planes 50e, 52e. Configuration planes 50e, 52e are positioned in parallel to one another. Central point axes 54e of lithium-ion secondary cells 24e through 42e are all situated on first configuration plane 50e or on additional configuration plane 52e. It is also conceivable that the energy storage unit has a different number of configuration planes 50e, 52e, for example, only one single configuration plane or three configuration planes.

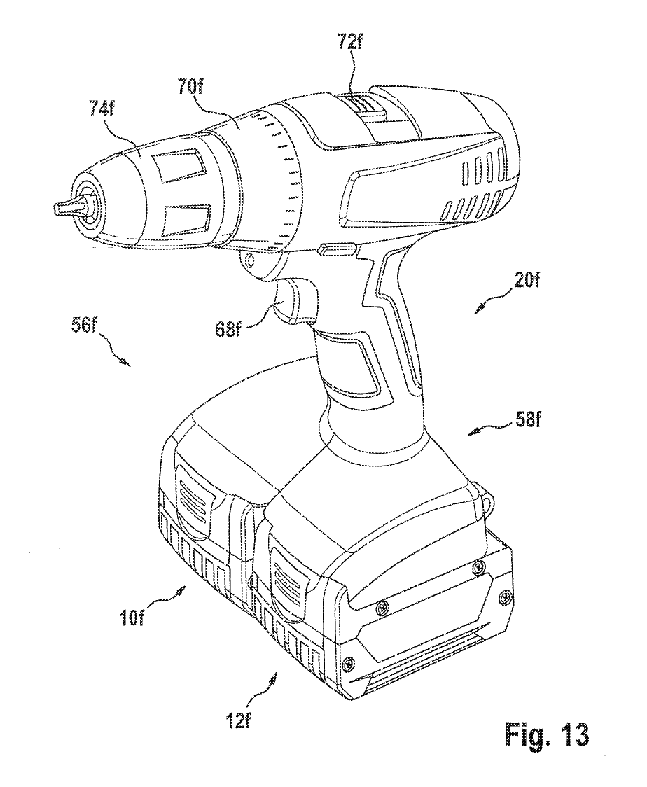

FIG. 13 shows a system 56f including a handheld power tool 20f and including two rechargeable battery devices 10f, 12f. Handheld power tool 20f is configured in the present exemplary embodiment as a cordless screwdriver. Handheld power tool 20f includes an electric drive unit, which includes an electric motor. Handheld power tool 20f furthermore includes a tool holder 74f for holding an insert tool, for example, of a screwdriver blade, a drill or a stirrer. The drive unit is provided for a rotatory operation of tool holder 74f.

Handheld power tool 20f is in the present exemplary embodiment configured in the shape of a pistol. Handheld power tool 20f includes a switching unit which is provided to switch handheld power tool 20f on and/or off and/or to set a speed and/or a torque. The switching unit includes an operating element 68f which is provided for an operation by a user. Operating element 68f is configured as a pressure switch. Handheld power tool 20f includes a torque limiter which is provided to set a torque maximally transferred by the drive unit to tool holder 74f. The torque limiter includes an adjustment ring 70f which is provided for an operation by the user. Handheld power tool 20f includes a gear shifting device which is provided to set a gear. The gear shifting device includes an operating element 72f which is provided for an operation by a user. Operating element 72f is configured in the present exemplary embodiment as a sliding element. Handheld power tool 20f is configured for a power supply by rechargeable battery devices 10f, 12f. In contrast to the first exemplary embodiment, handheld power tool 20f includes a rechargeable battery interface unit 58f which is provided for being coupled simultaneously to the two rechargeable battery devices 10f, 12f. It is conceivable that handheld power tool 20f is operatable with only one rechargeable battery device 10f, 12f.

Rechargeable battery devices 10f, 12f are similarly configured. Rechargeable battery devices 10f, 12f are configured identically to the rechargeable battery device of the first exemplary embodiment. Rechargeable battery devices 10f, 12f are provided for a power supply of the electric drive unit of handheld power tool 20f. Rechargeable battery devices 10f, 12f each include a housing and one energy storage unit. The energy storage units each include a plurality of lithium-ion secondary cells.

For the detachable attachment of rechargeable battery devices 10f, 12f to handheld power tool 20f or to a charging device, rechargeable battery devices 10f, 12f include a mechanical interface unit, similarly to the first exemplary embodiment, for the detachable mechanical connection to a rechargeable battery interface unit 58f of handheld power tool 20f or to a charging device not shown in greater detail. For a detachable electrical connection of rechargeable battery devices 10f, 12f to handheld power tool 20f or to a charging device not shown in greater detail, rechargeable battery devices 10f, 12f include an electrical interface unit for the detachable electrical connection to rechargeable battery interface unit 58f of handheld power tool 20f, similarly to the first exemplary embodiment.

The lithium-ion secondary cells are each configured cylindrically. The lithium-ion secondary cells are each configured in the shape of a straight circular cylinder and each have a cross section including a central point axis which corresponds to a cylinder axis. The lithium-ion secondary cells are similarly configured. The lithium-ion secondary cells include a main extension. The main extension and the central point axis of the lithium-ion secondary cells are each positioned in parallel to one another. The lithium-ion secondary cells include an identical maximum diameter. In the present exemplary embodiment, the maximum diameter of the lithium-ion secondary cells has a value between 19.5 mm and 22.5 mm. The lithium-ion secondary cells have an identical main extension which has a value between 64 mm and 71 mm. The lithium-ion secondary cells are each configured as a 20650 cell type or a 20700 cell type or a 22700 cell type.

In the present exemplary embodiment, the energy storage units of rechargeable battery devices 10f, 12f each include ten lithium-ion secondary cells. In the present exemplary embodiment, rechargeable battery devices 10f, 12f each include five groups of two lithium-ion secondary cells, each connected in parallel. The groups are each connected in series. The lithium-ion secondary cells have an identical nominal voltage of approximately 3.6 volts. Rechargeable battery devices 10f, 12f each have a nominal voltage of approximately 18.0 volts. Rechargeable battery devices 10f, 12f are connected in parallel in an installed state. It is also conceivable that rechargeable battery devices 10f, 12f are connected in series in the installed state.

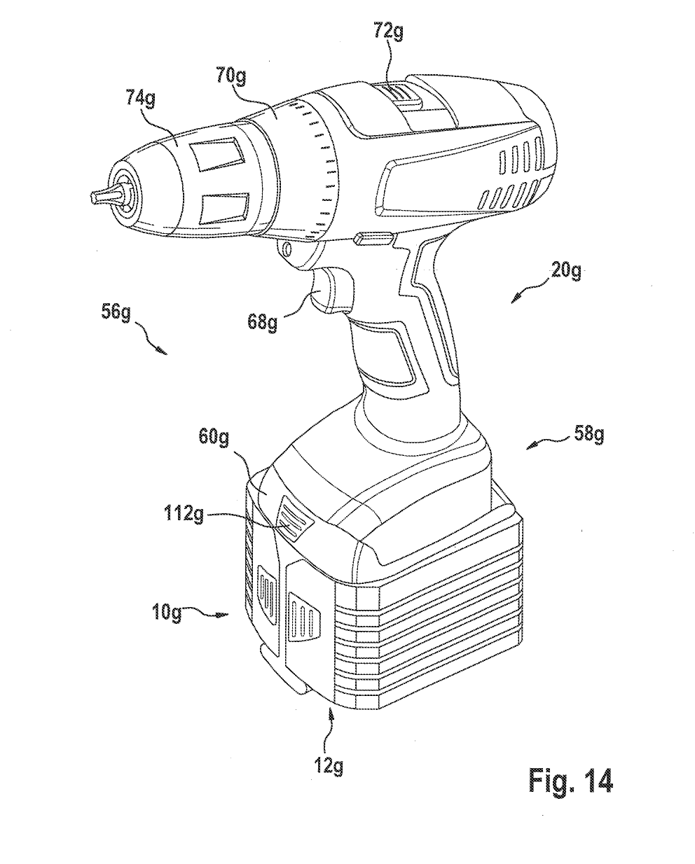

FIG. 14 shows a system 56g including a handheld power tool 20g and an adapter device 60g which includes a first interface 62g for coupling to handheld power tool 20g and a second interface 64g. Second interface 64g is provided to be simultaneously coupled to two rechargeable battery devices 10g, 12g. Handheld power tool 20g is configured similarly to the preceding exemplary embodiments as a cordless screwdriver. Handheld power tool 20g includes an electric drive unit, which includes an electric motor. Handheld power tool 20g furthermore includes a tool holder 74g for holding an insert tool, for example, of a screwdriver blade, a drill or a stirrer. The drive unit is provided for a rotatory drive of tool holder 74g. Handheld power tool 20g is in the present exemplary embodiment configured in the shape of a pistol. Handheld power tool 20g includes a switching unit which is provided to switch handheld power tool 20g on and/or off and/or to set a speed and/or a torque. The switching unit includes an operating element 68g which is provided for an operation by a user. Operating element 68g is configured as a pressure switch. Handheld power tool 20g includes a torque limiter which is provided to set a torque maximally transferred by the drive unit to the tool holder. The torque limiter includes an adjustment ring 70g which is provided for an operation by the user. Handheld power tool 20g includes a gear shifting device which is provided to set a gear. The gear shifting device includes an operating element 72g which is provided for an operation by a user. Operating element 72g is configured in the present exemplary embodiment as a sliding element.

Handheld power tool 20g is configured for a power supply by rechargeable battery devices 10g, 12g. It is conceivable that handheld power tool 20g is operatable with only one rechargeable battery device 10g, 12g. Handheld power tool 20g includes a rechargeable battery interface unit 58g for coupling to adapter device 60g. Rechargeable battery interface unit 58g is provided to be optionally coupled to adapter device 60g or to one of rechargeable battery devices 10g, 12g.

Rechargeable battery devices 10g, 12g are similarly configured. Rechargeable battery devices 10g, 12g are configured similarly to the rechargeable battery device of the first exemplary embodiment. Rechargeable battery devices 10g, 12g are provided for a power supply of the electric drive unit of handheld power tool 20g. Rechargeable battery devices 10g, 12g each include a housing and one energy storage unit. The energy storage units each include at least one lithium-ion secondary cell. The energy storage units each include a plurality of lithium-ion secondary cells.

For the detachable attachment of rechargeable battery devices 10g, 12g to handheld power tool 20g or to a charging device, rechargeable battery devices 10g, 12g include a mechanical interface unit, similarly to the first exemplary embodiment, for the detachable mechanical connection to a rechargeable battery interface unit 58g of handheld power tool 20g or to second interface 64g of adapter device 60g or to a charging device not shown in greater detail. For a detachable electrical connection of rechargeable battery devices 10g, 12g to handheld power tool 20g or to a charging device not shown in greater detail, rechargeable battery devices 10g, 12g each include an electrical interface unit, similarly to the first exemplary embodiment, for the detachable electrical connection to a rechargeable battery interface unit 58g of handheld power tool 20g or to second interface 64g of adapter device 60g or to a charging device not shown in greater detail.

The lithium-ion secondary cells are each configured cylindrically. The lithium-ion secondary cells are each configured in the shape of a straight circular cylinder and each have a cross section including a central point axis which corresponds to a cylinder axis. The lithium-ion secondary cells are similarly configured. The lithium-ion secondary cells include a main extension. The main extension and the central point axis of the lithium-ion secondary cells are each positioned in parallel. The lithium-ion secondary cells include an identical maximum diameter. In the present exemplary embodiment, the maximum diameter of the lithium-ion secondary cells has a value between 19.5 mm and 22.5 mm. The lithium-ion secondary cells have an identical main extension which has a value between 64 mm and 71 mm. The lithium-ion secondary cells are each configured as a 20650 cell type or a 20700 cell type or a 22700 cell type.

In the present exemplary embodiment, the energy storage units of rechargeable battery devices 10g, 12g each include ten lithium-ion secondary cells 24e through 42e. The lithium-ion secondary cells have an identical nominal voltage of approximately 3.6 volts. Rechargeable battery devices 10g, 12g each have a nominal voltage of approximately 18.0 volts.

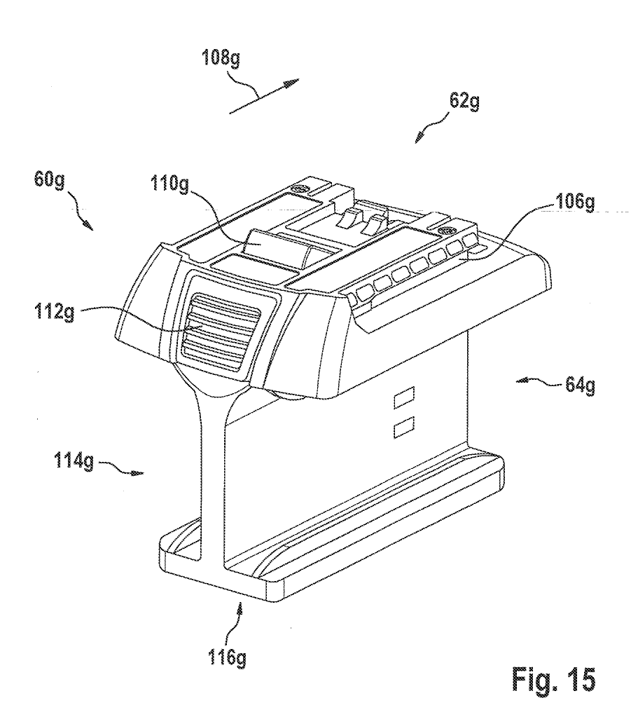

First interface 62g of adapter device 60g includes guide elements 106g in the form of guide grooves which are provided to act together with corresponding guide elements in the form of guide ribs at handheld power tool 20g. The guide grooves extend in the direction of an insertion direction 108g of adapter device 60g (see FIG. 15.) The guide grooves set insertion direction 108g. First interface 62g furthermore includes a locking element 110g in the form of a spring-loaded bolt. For the operation of locking element 110g, an operating element 112g is provided in the form of a push button. For locking adapter device 60g to handheld power tool 20g or the charging device, locking element 110g engages with a locking recess which is formed at rechargeable battery interface unit 58g of handheld power tool 20g or of a charging device.

Second interface 64g of adapter device 60g includes two accommodations 114g, 116g which are each provided for the coupling to one of rechargeable battery devices 10g, 12g. Accommodations 114g, 116g are each configured correspondingly to the mechanical interface units of rechargeable battery devices 10g, 12g and to the electrical interface units of rechargeable battery devices 10g, 12g. Accommodations 114g, 116g each include one coupling plane. The coupling plane of accommodations 114g, 116g are in the present exemplary embodiment positioned antiparallel to each other. It is also conceivable that accommodations 114g, 116g include one common coupling plane or that the coupling planes enclose an angle. First interface 62g includes a coupling plane. The coupling plane of first interface 62g and the coupling planes of second interface 64g are positioned perpendicularly to one another in the present exemplary embodiment. It is also conceivable that the coupling plane of first interface 62g and the coupling planes of second interface 64g are positioned antiparallel to one another or enclose an angle. Rechargeable battery devices 10g, 12g are connected in parallel in an installed state. It is also conceivable that rechargeable battery devices 10g, 12g are connected in series in an installed state.

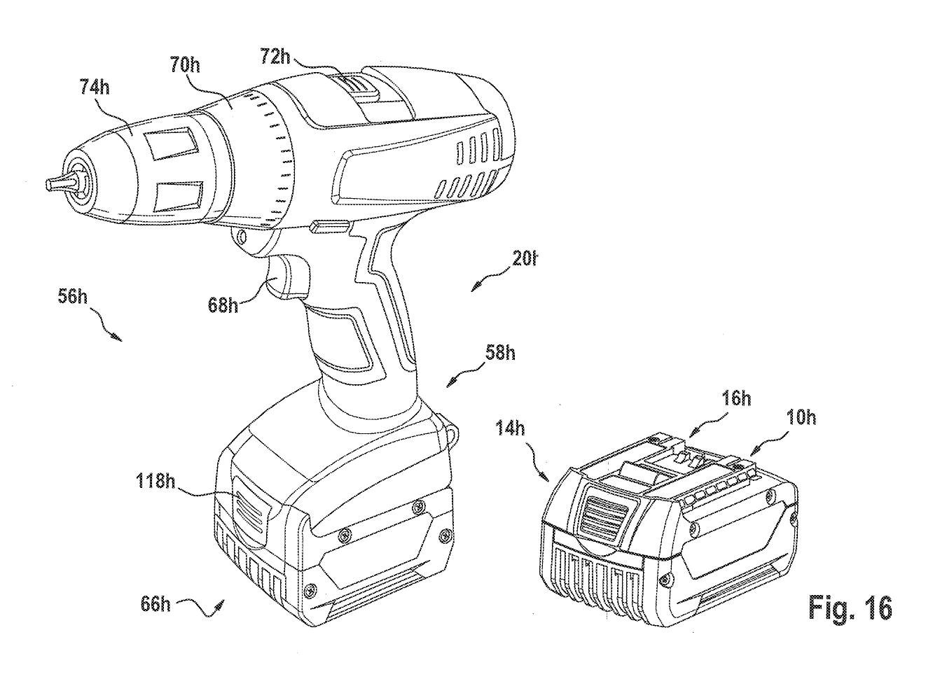

FIG. 16 shows a system 56h including a handheld power tool 20h and a rechargeable battery device 10h and including a replacement rechargeable battery device 66h. Handheld power tool 20h is configured in the present exemplary embodiment as a cordless screwdriver. Handheld power tool 20h includes an electric drive unit, which includes an electric motor. Handheld power tool 20h furthermore includes a tool holder 74h for holding an insert tool, for example, of a screwdriver blade, a drill or a stirrer. The drive unit is provided for a rotatory operation of tool holder 74h.

Handheld power tool 20h is in the present exemplary embodiment configured in the shape of a pistol. Handheld power tool 20h includes a switching unit which is provided to switch handheld power tool 20h on and/or off and/or to set a speed and/or a torque. The switching unit includes an operating element 68h which is provided for an operation by a user. Operating element 68h is configured as a pressure switch. Handheld power tool 20h includes a torque limiter which is provided to set a torque maximally transferred by the drive unit to tool holder 74h. The torque limiter includes an adjustment ring 70h which is provided for an operation by the user. Handheld power tool 20h includes a gear shifting device which is provided to set a gear. The gear shifting device includes an operating element 72h which is provided for an operation by the user. Operating element 72h is configured in the present exemplary embodiment as a sliding element. Handheld power tool 20h is configured for a power supply by rechargeable battery device 10h or by replacement rechargeable battery device 66h. Handheld power tool 20h includes a rechargeable battery interface unit 58h for rechargeable battery device 10h or replacement rechargeable battery device 66h. Handheld power tool 20h is optionally operatable using rechargeable battery device 10h or using replacement rechargeable battery device 66h.

Rechargeable battery device 10h is configured similarly to rechargeable battery device 10h of the first exemplary embodiment. Rechargeable battery device 10h is provided for a power supply of the electric drive unit of handheld power tool 20h. Rechargeable battery device 10h includes a housing 14h and an energy storage unit. The energy storage units include a plurality of lithium-ion secondary cells.

For the detachable attachment of rechargeable battery device 10h to handheld power tool 20h or to a charging device, rechargeable battery device 10h includes a mechanical interface unit 16h for the detachable mechanical connection to rechargeable battery interface unit 58h of handheld power tool 20h or to a charging device not shown in greater detail, similarly to the first exemplary embodiment. For a detachable electrical connection of rechargeable battery device 10h to handheld power tool 20h or to a charging device not shown in greater detail, rechargeable battery device 10h includes an electrical interface unit for the detachable electrical connection to rechargeable battery interface unit 58h of handheld power tool 20h, similarly to the first exemplary embodiment.

The lithium-ion secondary cells of the energy storage unit of rechargeable battery device 10h are each configured cylindrically. The lithium-ion secondary cells are each configured in the shape of a straight circular cylinder and each have a cross section including a central point axis which corresponds to a cylinder axis. The lithium-ion secondary cells are similarly configured. The lithium-ion secondary cells include a main extension 46e. The main extension and the central point axes of the lithium-ion secondary cells are each positioned in parallel to one another. The lithium-ion secondary cells include an identical maximum diameter. In the present exemplary embodiment, the maximum diameter of the lithium-ion secondary cells has a value between 19.5 mm and 22.5 mm. The lithium-ion secondary cells have an identical main extension which has a value between 64 mm and 71 mm. The lithium-ion secondary cells are each configured as a 20650 cell type or a 20700 cell type or a 22700 cell type.

The lithium-ion secondary cells have an identical nominal voltage of approximately 3.6 volts. Rechargeable battery device 10h has a nominal voltage of approximately 18.0 volts. It is conceivable that the energy storage unit includes a different number of lithium-ion secondary cells, for example, three, four, five, six, seven, eight, fourteen, twenty or thirty lithium-ion secondary cells.

Replacement rechargeable battery device 66h is provided for a power supply of the electric drive unit of handheld power tool 20h. Replacement rechargeable battery device 66h includes a housing 118h and an energy storage unit. The energy storage units include a plurality of lithium-ion secondary cells. It is conceivable that the replacement rechargeable battery device includes rechargeable battery cells having another chemical composition, for example, sodium-ion cells, nickel-ion cells, zinc-ion cells or tin-ion cells.

For the detachable attachment of replacement rechargeable battery device 66h to handheld power tool 20h or to a charging device, replacement rechargeable battery device 66h includes a mechanical interface unit for the detachable mechanical connection to a rechargeable battery interface unit 58h of handheld power tool 20h or to a charging device not shown in greater detail. For a detachable electrical connection of replacement rechargeable battery device 66h to handheld power tool 20h or to a charging device not shown in greater detail, replacement rechargeable battery device 66h includes an electrical interface unit for the detachable electrical connection to rechargeable battery interface unit 58h of handheld power tool 20h.

The lithium-ion secondary cells of the energy storage unit of replacement rechargeable battery device 66h are each configured cylindrically. The lithium-ion secondary cells are similarly configured. The lithium-ion secondary cells include an identical maximum diameter. In the present exemplary embodiment, the maximum diameter of the lithium-ion secondary cells has a value of approximately 18 mm. The lithium-ion secondary cells have an identical main extension which has a value of approximately 65 mm. The lithium-ion secondary cells are each configured as a 18650 cell type.

The lithium-ion secondary cells have an identical nominal voltage of approximately 3.6 volts. The replacement rechargeable battery device has a nominal voltage of approximately 18.0 volts. It is conceivable that the energy storage unit includes a different number of lithium-ion secondary cells, for example, three, four, five, six, seven, eight, fourteen, twenty or thirty lithium-ion secondary cells.

What is claimed is:

1. A rechargeable battery device, comprising:
a housing;
a mechanical interface unit to a detachable coupling to a handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

2. The rechargeable battery device of claim 1, wherein the at least one lithium-ion secondary has a maximum diameter which has a value from a value range between 19.5 mm and 20.5 mm.

3. The rechargeable battery device of claim 1, wherein the at least one lithium-ion secondary cell has a maximum diameter which has a value from a value range between 21.5 mm and 22.5 mm.

4. The rechargeable battery device of claim 1, wherein the at least one lithium-ion secondary cell has a volume which has a value from a value range between 19.9 cm³ and 27.1 cm³.

5. The rechargeable battery device of claim 1, wherein the at least one lithium-ion secondary cell has a main extension which has a value from a value range between 64 mm and 71 mm.

6. The rechargeable battery device of claim 1, wherein the at least one lithium-ion secondary cell is configured as a 20650 cell type, a 20700 cell type, or as a 22700 cell type.

7. The rechargeable battery device of claim 1, wherein the at least one lithium-ion secondary cell has a capacity of at least 3.0 Ah.

8. The rechargeable battery device of claim 1, wherein the at least one lithium-ion secondary cell has an energy density of at least 500 Wh/l.

9. The rechargeable battery device of claim 1, wherein the at least one energy storage unit has a total cell volume between 60.8 cm³ and 220.4 cm³.

10. The rechargeable battery device of claim 1, wherein the at least one energy storage unit) has a total cell volume between 79.3 cm³ and 266.6 cm³.

11. The rechargeable battery device of claim 1, wherein the at least one energy storage unit (22a; 22c; 22d) has a total cell volume between 122.0 cm³ and 440.3 cm³.

12. The rechargeable battery device of claim 1, wherein the at least one energy storage unit has a total cell volume between 159.2 cm³ and 532.7 cm³.

13. The rechargeable battery device of claim 1, wherein the at least one energy storage unit has a total cell volume between 612.1 cm³ and 660.2 cm³.

14. The rechargeable battery device of claim 1, wherein the at least one energy storage unit has a total cell volume between 797.8 cm³ and 798.8 cm³.

15. The rechargeable battery device of claim 1, wherein the mechanical interface unit has an insertion direction which is positioned at least essentially in parallel to a main extension of the at least one lithium-ion secondary cell.

16. The rechargeable battery device of claim 1, wherein the mechanical interface unit has an insertion direction which is situated at least essentially perpendicularly to a main extension of the at least one lithium-ion secondary cell.

17. The rechargeable battery device of claim 1, wherein the at least one energy storage unit includes a configuration plane and a plurality of lithium-ion secondary cells, which have an identical cross section, each including a central point axis, which are all situated on the configuration plane.

18. The rechargeable battery device of claim 1, wherein the at least one energy storage unit includes one first configuration plane and at least one additional configuration plane and a plurality of lithium-ion secondary cells which have an identical diameter each including a central point axis, a part of the central point axes being situated on the first configuration plane and an additional part being situated on the additional configuration plane.

19. A system, comprising:
a handheld power tool; and
a rechargeable battery device, including:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

20. A system, comprising:
a handheld power tool;
at least two rechargeable battery devices, each including:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm; and
at least one rechargeable battery interface unit which is couple-able simultaneously to the at least two rechargeable battery devices.

21. A system, comprising:
a handheld power tool;
at least one adapter device which includes one first interface for the coupling to the handheld power tool and at least one second interface which is couple-able simultaneously to at least two rechargeable battery devices;
wherein each of the at least two rechargeable battery devices include:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

22. A system, comprising:
a handheld power tool;
at least one rechargeable battery device; and
at least one replacement rechargeable battery device which includes at least one lithium-ion secondary cell of the 18650 type;
wherein the handheld power tool is optionally operatable using the rechargeable battery device or the replacement rechargeable battery device, and
wherein the at least one rechargeable battery device includes:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

23. A handheld power tool device for a system, comprising:
a handheld power tool;
wherein the system includes the handheld power tool, and a rechargeable battery device, including:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

24. An adapter device for a system, comprising:
at least one adapter device which includes one first interface for the coupling to the handheld power tool and at least one second interface which is couple-able simultaneously to at least two rechargeable battery devices;
wherein the system includes a handheld power tool and the at least one adapter device,
wherein each of the at least two rechargeable battery devices include:
a housing;
a mechanical interface unit to a detachable coupling to the handheld power tool;
an electrical interface unit to a detachable coupling to the handheld power tool; and
at least one energy storage unit, which is situated in the housing and includes at least one at least essentially cylindrical lithium-ion secondary cell;
wherein the at least one lithium-ion secondary cell has a maximum diameter which has a value from a value range between 19.5 mm and 22.5 mm.

25. The rechargeable battery device of claim 1, wherein the rechargeable battery device is a handheld power tool rechargeable battery device.
